(19) United States
(12) Patent Application Publication
(10) Pub. No.: US 2010/0190029 A1
(43) Pub. Date: Jul. 29, 2010

(54) METAL LAYER LAMINATE HAVING ROUGHENED METAL SURFACE LAYER AND METHOD FOR PRODUCING THE SAME

(75) Inventor: Shiki Ueki, Kanagawa (JP)

Correspondence Address: Solaris Intellectual Property Group, PLLC, 401 Holland Lane, Suite 407, Alexandria, VA, 22314, US

(73) Assignee: FUJIFILM CORPORATION, Minato-ku, Tokyo (JP)

(21) Appl. No.: 12/666,807

(22) PCT Filed: Jun. 9, 2008
(86) PCT No.: PCT/JP2008/060554

§ 371 Date: Dec. 28, 2009

(30) Foreign Application Priority Data
Jun. 27, 2007 (JP) 2007-169204

(51) Int. Cl. B32B 5/00; C25D 5/56; B05D 5/12

(52) U.S. Cl. 428/687; 205/164; 427/99.5

(57) ABSTRACT

Provided are a metal layer laminate that includes a roughened metal surface layer having a surface profile capable of strongly adhering to resin materials even when the surface roughness is small, and a simple method for producing a metal layer laminate having good adhesion to resin materials such as a resin substrate for a metal layer and an insulating resin film formed on the surface of a metal wiring portion. The metal layer laminate includes a metal layer, a resin thin film, and a roughened metal surface layer, wherein the resin thin film and the roughened metal surface layer are formed on the surface of the metal layer, a fractal-shaped interface structure appears between the resin thin film and the roughened metal surface layer, when the metal layer laminate is cut in a normal direction, and the interface structure has a fractal dimension of 1.05 to 1.50 as calculated using a box counting method with the measurement object region being set to from 50 nm to 5 μm and the box size (pixel size) being set to 1/100 or less of the measurement object region. The metal layer laminate is obtained by a production method including the steps of forming a resin thin film on the surface of a metal layer and subjecting the resin thin film-carrying metal layer to a plating process.

### TECHNICAL FIELD

The present invention relates to a metal layer laminate having a roughened surface layer having good adhesion to a resin layer and to a method for production thereof. In particular, the invention relates to a metal layer laminate having a surface profile useful for forming metal circuit boards or printed circuit boards and to a simple method for production thereof.

### BACKGROUND ART

Printed circuit boards in which a laminated plate composed of an insulating material and an electrically-conductive material is processed to form a circuit are used for electronic circuits in electronic devices. Printed circuit boards have a patterned conductor that is made of an electrically-conductive material and formed and fixed on the surface of an insulating substrate and to the interior of the insulating substrate, based on electrical designs. Printed circuit boards are broadly classified into plate-shaped rigid circuit boards and flexible circuit boards having high flexibility according to the type of the substrate-forming resin. In particular, flexible circuit boards characterized by having flexibility are essential components for connections in moving parts which constantly undergo repeated bending.

In order to ensure the adhesion between an organic material such as a resin and a metal layer in conventional printed boards, for example, the resin substrate is subjected to surface-roughening treatment such as permanganic acid treatment, and when the process of forming a wiring portion is followed by the process of forming an insulating resin layer on the surface of the wiring portion, the upper surface of the metal wiring portion is subjected to surface-roughening treatment such as chemical etching. In either case, irregularities of several microns or more are formed on the surface. In this way, adhesion between organic materials and metals is generally achieved through a process of forming irregularities on the surface.

In such surface-roughening methods, as conductor lines are made finer, it becomes impossible to maintain adhesion between the conductor lines and the substrate or a solder resist or an upper insulating layer, so that the conductor lines themselves may also be difficult to form and that the resulting printed board may also often suffer from separation or breakage of the conductor lines. Therefore, the printed board may often break down, and the reliability of the printed board may be difficult to maintain. Further, when irregularities are simply made small and smooth, high frequency transmission is improved, but the above problem with adhesion is not overcome.

In recent years, finer wiring (higher density or finer pitch) has been demanded, and there have been concerns regarding the possibility of surface irregularities having an adverse effect on high frequency transmission. Thus, there has been a demand for techniques that can improve adhesion, while the surface smoothness is kept at such a level that the necessary properties of the metal layer itself are not degraded in a fine layer or a metal layer such as a thin layer.

In order to solve these problems, for example, a method for increasing the adhesion between a substrate and a wiring portion, in which a surface graft polymer is used so that the adhesion of a metal layer can be improved, while the irregularities of the substrate can be kept minimal, has been proposed (see, for example, Japanese Patent Application Laid-Open (JP-A) No. 58-196238 and Advanced Materials Vol. 20 (2000), pp. 1481-1494). The method using the graft polymer requires very expensive equipment (such as a γ-ray generator or an electron beam generator) and there is the possibility that a graft polymer effective for strong adhesion of the metal layer may not be produced at a practically sufficient level.

A method for increasing the adhesion between a wiring portion and a cover lay, namely, between the upper surface of the wiring portion and an insulating resin layer, which includes using an organic surface-treatment agent capable of strongly interacting with copper, such as a triazine compound having a thiol group, has been proposed (see, for example, JP-A No. 2005-306023). This method is somehow effective in improving the adhesion between the wiring portion and the resin layer placed on the upper surface of the wiring portion but is not applicable to applications requiring an improvement in the adhesion between a wiring portion and a substrate located therebelow. This method also requires at least a certain copper surface area, namely at least a certain level of surface roughness, because the adhesion depends on the chemical bond (coordinate bond) to copper as a component of the wiring portion. This method is also limited as to what type of metal can be used and has the problem of a lack of general versatility.

Another method, which includes depositing a metal oxide on a metal surface and reducing the metal oxide to form a roughened layer, has been proposed (see for example JP-A No. 05-33193). In this method, however, the oxidation proceeds from crystal grain boundary portions, so that the roughened surface obtained after removal of the oxide film tends to have an edged structure with respect to a metal foil. Therefore, it has low resistance to shearing or tensile stress and is not considered to have sufficient resistance to a heat cycle test, which is essential for the quality assurance of printed boards or flexible boards that are particularly required to have folding resistance.

In this method, the pitch of irregularities of the roughened surface depends on the crystal grain size, and therefore, the surface roughness Ra has to be increased in order to produce high adhesion strength by this method.

As described above, various methods to improve the adhesion between a resin and a metal foil mainly composed of copper with reduced increase in surface roughness have been studied, but there is no known method that satisfies this requirement.

### DISCLOSURE OF INVENTION

### Objects to be Achieved by the Invention

In view of the above problems, an object of the invention is to provide a metal layer laminate that includes a roughened metal surface layer having a surface profile capable of strongly adhering to resin materials even when the surface roughness is small, and to provide a simple method for producing a metal layer laminate having good adhesion to resin materials such as a resin substrate for a metal layer and an insulating resin film formed on the surface of a metal wiring portion.

### Means for Solving the Problems

As a result of investigations, the above problems have been addressed by the inventor of the present invention, and the inventor has made the invention based on the finding that when a roughened metal surface layer having a fine fractal structure is provided on a metal surface.

Specifically, aspects of the invention are as follows.

(1) A metal layer laminate, including a metal layer, a resin thin film, and a roughened metal surface layer, wherein the resin thin film and the roughened metal surface layer are formed on the surface of the metal layer, a fractal-shaped interface structure appears between the resin thin film and the roughened metal surface layer, when the metal layer laminate is cut in a normal direction, and the interface structure has a fractal dimension of from 1.05 to 1.50 as calculated using a box counting method with the measurement object region being set to from 50 nm to 5 μm and the box size (pixel size) being set to 1/100 or less of the measurement object region.
(2) The metal layer laminate of item (1), wherein the interface structure has a fractal dimension of from 1.1 to 1.4.
(3) The metal layer laminate of item (1), wherein the resin of the resin thin film is a thermosetting resin, a thermoplastic resin or a mixture thereof.
(4) The metal layer laminate of item (3), wherein the resin thin film comprises at least one selected from the group consisting of epoxy resin, phenolic resin, polyimide resin, polyester resin, bismaleimide resin, polyolefin resin, isocyanate resin, phenoxy resin, polyether sulfone, polysulfone, polyphenylene sulfone, polyphenylene sulfide, polyphenyl ether, and polyether imide.
(5) A method for producing a metal layer laminate including a metal layer and a roughened metal surface layer provided on the surface of the metal layer, including: forming a resin thin film on a surface of a metal layer; and immersing the resin thin film-carrying metal layer in an electroplating solution or an electroless plating solution to subject it to a plating process.
(6) The method of item (5), wherein the metal layer is a metal foil or a metal wiring portion of a printed circuit board including a substrate and a circuit formed thereon.
(7) The method of item (5) or (6), wherein the metal layer has an arithmetic mean roughness Ra of 0.5 μm or less as determined according to ISO 4287 1997 (JIS B-0601).
(8) The method of any one of items (5) to (7), wherein the resin thin film has a thickness in the range of 0.1 to 10 μm, and a metal ion or a metal salt present in the plating solution used in the electroplating or the electroless plating has a diffusion coefficient of 10⁻⁴ m²/second to 10⁻¹⁰ m²/second in the resin thin film.
(9) The method of any one of items (5) to (8), wherein the roughened metal surface layer has an arithmetic mean roughness Ra of 0.5 μm or less as determined according to ISO 4287 1997 (JIS B-0601).
(10) The method of any one of items (5) to (9), wherein a fractal-shaped interface structure appears between the roughened metal surface layer and the resin thin film, when the metal layer laminate is cut in a normal direction, and the interface structure has a fractal dimension of from 1.05 to 1.50 as calculated using a box counting method with the measurement object region being set to from 50 nm to 5 μm and the box size (pixel size) being set to 1/100 or less of the measurement object region.
(11) The metal layer laminate of item (5), wherein the resin thin film comprises a thermosetting resin, a thermoplastic resin or a mixture thereof; and
(12) The metal layer laminate of item (11), wherein the resin thin film comprises at least one selected from the group consisting of epoxy resin, phenolic resin, polyimide resin, polyester resin, bismaleimide resin, polyolefin resin, isocyanate resin, phenoxy resin, polyether sulfone, polysulfone, polyphenylene sulfone, polyphenylene sulfide, polyphenyl ether, and polyether imide.

The production method of the invention utilizes a reductive metal deposition method in which a polymer chain is used. When a resin thin film is formed on the surface of a metal layer and then subjected to a plating process, a metal ion or a metal salt is allowed to diffuse or infiltrate into the resin thin film and reduced and deposited on the surface of the metal layer as a base, so that a roughened metal surface layer is newly formed, which is closely bonded to the metal layer and has a fractal metal surface (a metal surface having a complicated structure). This metal surface has a low surface roughness; however, because of its complicated and fine surface irregularities, this metal surface has a surface area with which the adhesion strength between the metal and the resin can be increased over the wiring portion. Therefore, a metal layer laminate obtained by this production method is useful in producing printed circuit boards suitable for higher density, finer pitch and higher frequency.

The production method of the invention is characterized in that the resin layer is first formed, and then the roughened metal surface layer is formed using deposited metal. The production method of the invention achieves an improvement in adhesion between metal and resin layers through this unusual process, namely, the process of forming the resin layer directly on the surface of a flat metal layer. The production method of the invention is thus a simple and novel method with a wide range of choices of material.

In an embodiment of the invention, the “surface roughness Ra” is based on the arithmetic mean roughness (Ra) according to ISO 4287 (1997) (JIS B-0601 (1994)). The surface roughness may be evaluated by the roughness evaluation procedure according to ISO 4288 (1996) (JIS B-0633 (2001)).

The “fractal dimension (box-counting dimension)” used in an embodiment of the invention may be defined as follows. When the number of boxes needed to cover a certain figure F is represented by N_{δ}(F) and the size of the boxes is represented by δ, the box dimension is defined by the following formula.

$${D}_{8} = - {lim}_{δ \to 0} \frac{log {N}_{δ} ( F )}{log δ}$$

In the definition, for example, each box may be a sphere having a radius of δ or a cube having a side of δ. The dimension value is not affected by the shape of the box.

In this method, the calculated fractal dimension may vary depending on differences in the box size (pixel size), which corresponds to the resolution, and the measurement object region, which corresponds to the size of the visual field. In view of this, in an embodiment of the invention, when the fractal dimension is determined, the measurement object region is defined in the range of from 50 nm to 5 μm, and the size δ (box size or pixel size) is defined in the range of 1/100 or less of the measurement object region, in consideration of the shape of fine surface irregularities necessary for the roughened metal surface layer and smoothness that will have no effect on the high frequency properties.

### EFFECTS OF THE INVENTION

The invention is based on a crystal deposition method under an unstable environment, which includes forming a thin resin layer on a metal surface and then depositing metal by a plating process. In an embodiment of the invention, the use of the resin thin layer makes it possible to form a fine and highly complicated crystal structure (diffusion limited aggregation), specifically, a typical fractal structure, by deposition. Since the crystal structure is fine and complicated, a very high level of interlocking with resins and a very large contact area between resin and metal can be achieved.

Accordingly, a metal layer laminate that includes a roughened metal surface layer having a surface profile capable of strongly adhering to resin materials even when the surface roughness thereof is small, and a simple method for producing a metal layer laminate having good adhesion to resin materials such as a resin substrate for a metal layer and an insulating resin film formed on the surface of a metal wiring portion, are provided.

### BRIEF DESCRIPTION OF THE DRAWING

FIG. 1 is an image showing an interface portion (line segments) extracted from a photograph of the cross-section of the roughened metal surface layer and the resin thin film in the metal layer laminate of Example 1.

### BEST MODE FOR CARRYING OUT THE INVENTION

The metal layer laminate of the invention and the method for production thereof are described in detail below.

The metal layer laminate of the invention includes a metal layer, a roughened metal surface layer and a resin thin film, wherein the roughened metal surface layer and the resin thin film are formed on the surface of the metal layer, a fractal-shaped interface structure appears between the resin thin film and the roughened metal surface layer when the metal layer laminate is cut in a normal direction, and the interface structure has a fractal dimension of from 1.05 to 1.50 as calculated using a box counting method with the measurement object region being set to 50 nm to 5 μm and the box size (pixel size) being set to 1/100 or less of the measurement object region.

In an embodiment of the invention, the surface of the roughened metal surface layer formed on the metal layer as a base has fractal-shaped fine irregularities that satisfy the above requirement. Even when having a small surface roughness, therefore, the roughened metal surface layer has a sufficient surface area because of its complicated surface profile, so that it has good adhesion to a resin layer that is formed of a resin material and is adjacent thereto.

Therefore, the metal layer laminate of the invention is suitable for use in forming metal wiring boards having metal wire portions, in coating metal surfaces with various resin layers, in forming design resin films, or other applications.

Metal Layer

In an embodiment of the invention, the metal layer as a base having a surface on which the roughened metal surface layer is to be formed may not be particularly limited. The metal layer itself may be a solid metal or a thin layer of metal. The metal layer may also be formed on any solid surface, and, for example, the metal layer may be a metal wiring portion or the like in an embodiment of the invention. In particular, the invention is useful for manufacturing general-purpose multilayer circuit boards, more specifically, multilayer flexible circuit boards, in applications in which the metal layer is bonded to flexible resin materials. In view of this point, the invention is significantly effective when a metal foil or a metal wiring portion formed on the surface of any substrate, or the like is used as the metal layer.

The metal used to form the metal layer is not particularly limited, and the metal may be appropriately selected from a variety of metals as long as any of electroless plating and electroplating is applicable to the formed metal layer. The metal may be a simple metal or an alloy. A metallic material containing a filler or any other additive may also be used.

The metal of the metal layer for use in an embodiment of the invention may be of any type. The metal type may be appropriately selected as needed. For metal resin laminate applications or printed circuit board applications, the metal is preferably copper, silver, gold, palladium, platinum, nickel, or aluminum, more preferably copper, silver or gold, in view of electric conductivity or corrosive properties.

For circuit board applications, the thickness of the metal layer, specifically the thickness of a metal foil or the height of a metal wiring portion, is preferably in the range of 2 μm to 100 μm, and more preferably 5 μm to 50 μm.

The metal layer laminate of the invention is particularly effective for fine wiring, as compared with metal wiring in conventional printed circuit boards. Specifically, it is effective for the fine wiring having a width of 3 μm to 200 μm, and more effectively 5 μm to 50 μm.

The production method of the invention may be used regardless of the state of irregularities of the metal layer as a base. When the method of the invention is applied to the production of the circuit board described later, the metal layer to be used preferably has a surface roughness Ra of 0.8 μm or less, and more preferably 0.5 μm or less, in view of wiring characteristics. According to the invention, even when the metal layer with such a smooth surface is used, a roughened metal surface layer having improved adhesion to a resin layer may be formed.

Formation of Resin Thin Film on Surface of Metal Layer

In the method of the invention for producing a metal layer laminate, a resin thin film is formed on the metal layer, more specifically on a metal foil or a wiring portion formed on a printed wiring board (circuit board).

The resin thin film may be formed by known methods such as coating methods or transfer methods.

The resin thin film formed in this step should have a uniform thickness and no defect. For example, when defects such as cissing are produced on a coating surface in the process of forming the resin thin film by a coating method, metal deposition is more likely to be concentrated on the defective portions in the process of forming the roughened metal surface layer described later, resulting in difficulty in forming a surface having the desired fine irregularities.

Any of a thermosetting resin, a thermoplastic resin and a mixture thereof may be used as a resin material for forming the resin thin film. If the resin thin film is dissolved or separated when it is immersed in a plating bath for a time period required to form the roughened metal surface layer, the resin thin film cannot be kept uniform. Therefore, such an extremely water-soluble resin or a resin that is extremely acid- or alkali-soluble so that the film thereof can be dissolved or separated during plating on the resin is not suitable for the resin film in an embodiment of the invention.

Examples of resin materials that may be used to form the resin film include thermosetting resins such as epoxy resins, phenolic resins, polyimide resins, polyester resins, bismaleimide resins, polyolefin resins, and isocyanate resins.

Examples of the epoxy resins include cresol novolac epoxy resins, bisphenol A epoxy resins, bisphenol F epoxy resins, phenol novolac epoxy resins, alkylphenol novolac epoxy resins, biphenol F epoxy resins, naphthalene epoxy resins, dicyclopentadiene epoxy resins, epoxy compounds of condensates of phenols and aromatic aldehydes having a phenolic hydroxyl group, triglycidyl isocyanurate resins, and alicyclic epoxy resins. These may be used singly or in combination of two or more thereof. Resin thin films having a high level of heat resistance and the like may be formed using such epoxy resins.

Examples of the polyolefin resins include polyethylene resins, polystyrene resins, polypropylene resins, polyisobutylene resins, polybutadiene resins, polyisoprene resins, cycloolefin resins, and copolymers of these resins.

Examples of the thermoplastic resins include phenoxy resins, polyether sulfone, polysulfone, polyphenylene sulfone, polyphenylene sulfide, polyphenyl ether, and polyether imide.

Examples of other thermoplastic resins include (1) 1,2-bis(vinylphenylene)ethane resin (1,2-bis(vinylphenyl)ethane resin) or modifications thereof with polyphenylene ether resins (described in Satoru Amou et al., Journal of Applied Polymer Science Vol. 92, 1252-1258 (2004)), and fluororesins (PTFE).

These resin materials may be used singly or in combination of two or more thereof depending on purpose. When two or more resins are used, different types of thermoplastic or thermosetting resins may be used in combination, or a combination of thermoplastic resin and thermosetting resin may also be used.

Examples of other resins that may be used in an embodiment of the invention include photo-curable resins such as acrylic photosensitive resins and photosensitive polyimide. When such resins are used, the resin material is applied by coating and photo-cured to form the resin thin film. These resins are not intended to limit the range of available resins. Water-soluble resins such as polyvinyl alcohol may also be used to form the resin film, as long as they can maintain a uniform resin thin film even after immersion in a plating bath for a given period of time.

Thus, there are few limits on the type of the resin or the basic skeleton of the resin itself. Rather, there is a significant dependence on film production conditions such as drying conditions for forming the film or polymerization conditions when a polymerizable polymer is used, on the free volume or the degree of swelling in the plating bath, or on the degree of ease of infiltration of plating bath metal salts or ions into the resin thin film.

In order to form the preferred interface profile according to the invention, it is important to control the diffusion coefficient and the film thickness, which are properties for the infiltration. The thickness of the resin thin film is preferably 10 μm or less, and more preferably in the range of 0.3 μm to 5 μm.

The film thickness may be calculated from the amount of the coating after drying.

Metal salts or ions from the plating bath preferably have a diffusion coefficient of from 10⁻⁴ to 10⁻¹⁰ m²/second, and more preferably from 10⁻⁴ to 10⁻⁷ m²/second, in the resin thin film.

In view of the effect, the above conditions on the diffusion coefficient and the film thickness are preferably satisfied.

Method for Measuring Diffusion Coefficient

A method for measuring the diffusion coefficient of a metal salt or metal ion in a resin in an embodiment of the invention is described below. While a description is given below of a case where copper ions are used as the objects to be measured, other objects may also be measured in the same manner.

First, the resin to be subjected to measurement is used to form an about 0.4 μm-thick resin thin film on a silicon substrate, and the resultant product is used as a measurement sample. A plurality of measurement samples are prepared and immersed in a copper ion-containing plating bath for different periods of time, respectively. The amount of copper ions present in the direction of the depth of each measurement sample taken out of the plating bath is calculated using RBS (Rutherford Backscattering Spectrometry) method. This process is performed for the measurement samples which had been immersed for different periods of time, and the diffusion coefficient D is determined by fitting using a diffusion equation.

Plating of Resin Thin Film-Carrying Metal Layer

The resin thin film-carrying metal layer obtained as described above is subjected to a plating process by immersing it in an electroplating bath or an electroless plating bath, so that a fractal-shaped (DLA (Diffusion Limited Aggregation)-like) metal fine structure is deposited from the metal layer surface as a base point into the resin thin film, and a roughened metal surface layer is formed. The roughened metal surface layer is formed as a fractal structure, because the metal deposition proceeds in the resin film and because the polymer chain serves as an inhibitor of the metal crystal growth (orientation). The shape or size of the deposited metal structure significantly varies with various plating bath conditions, while it also varies depending on the diffusion coefficient or the composition of the resin.

Electroplating

Known conventional electroplating (electrolytic plating) methods may be used in this step. Metals that may be used for electroplating in this step include copper, chromium, lead, nickel, gold, silver, tin, zinc, and the like. When the method of the invention is used to form a wiring portion, copper, gold and silver are preferred in view of conductivity, and copper is more preferred.

When the resin thin film-carrying metal layer is subjected to electroplating by immersing it in an electroplating bath, a fractal-shaped (diffusion limited aggregation-like) fine metal structure (roughened metal surface layer) is deposited from the metal layer surface as a base point into the resin thin film. The structure and size of the roughened metal surface layer may be controlled by controlling the metal salt or ions present in the electroplating bath, the properties of the resin thin film, and other factors such as the temperature of the plating bath, the immersion time, the concentration of the metal salt or ions, the voltage, and the way of applying the voltage (such as linear, stepwise or pulsed voltage application). More specifically, the voltage is preferably as low as possible in the voltage range where plating is possible, specifically about 20 V or less, and more preferably about 3V or less. In the case of stepwise voltage application, the initial voltage is preferably controlled to be low similarly to the above, in view of the fractal structure formation. When the applied voltage is too high (for example, when a voltage of more than 100 V is applied), the in-plane shape of the deposited metal may tend to be uniform, which is not preferred in view of the effect of improving the adhesion.

The time of immersion in the electroplating bath is preferably from about 1 minute to about 3 hours, and more preferably from about 1 minute to about 1 hour.

Taking into account the electrical contact resistance and the like in the case of forming a wiring portion, the metal to be deposited by the electroplating method, namely, the metal that forms the roughened metal surface layer is preferably the same as the metal that forms the metal layer. If necessary, however, a metal different from that of the metal layer as a base may be used to form the roughened metal surface layer due to the characteristics of the electroplating step.

Electroless Plating

In the plating step, electroless plating may be performed, as well as the electroplating. The term “electroless plating” refers to a process in which metal is deposited by a chemical reaction using a solution of ions of the metal to be deposited by plating.

In the electroless plating, a common commercially-available activator (e.g., trade name: OPC-80 CATALYST M, manufactured by OKUNO CHEMICAL INDUSTRIES CO, LTD.) or accelerator (e.g., trade name: OPC-555 ACCELERATOR M, manufactured by OKUNO CHEMICAL INDUSTRIES CO, LTD.) may be used in combination. A commercially-available plating solution (e.g., ATS ADDCOPPER IW (trade name) manufactured by OKUNO CHEMICAL INDUSTRIES CO, LTD.) may also be used as the electroless plating solution.

When electroless plating is used in the plating step, for example, a pretreatment step for removing the surface oxide film of the metal layer using a strong acid such as hydrochloric acid or sulfuric acid is preferably performed, and then the electroless plating is preferably performed to form the resin thin film.

A common electroless plating bath composition generally includes (1) metal ions for plating, (2) a reducing agent, and (3) an additive (stabilizer) that improves the stability of the metal ions. Besides these components, the plating bath may also contain any other publicly known additive such as a plating bath stabilizer.

Known examples of metals used in electroless plating baths include silver, chromium, copper, tin, lead, nickel, gold, palladium, and rhodium. In view of electrical conductivity, silver, copper, chromium, and nickel are particularly preferred.

A certain optimal reducing agent and additive are known for each selected metal. For example, copper electroless plating baths generally contain Cu(SO₄)₂ as a copper salt, HCOH as a reducing agent, and a chelating agent such as EDTA or Rochelle salt, which is a copper ion stabilizer, as an additive. Plating baths for use in CoNiP electroless plating preferably contain cobalt sulfate or nickel sulfate as the metal salt, sodium hypophosphite as a reducing agent, and sodium malonate, sodium malate, or sodium succinate as a complexing agent. Palladium electroless plating baths preferably contain (Pd(NH₃)₄)Cl₂ as a metal ion source, H₂NNH₂ as a reducing agent, and EDTA as a stabilizer. These plating baths are shown as typical examples and may also contain other components depending on the purpose.

When the resin thin film-carrying metal layer is immersed in any of such electroless plating baths, a fractal-shaped (diffusion limited aggregation-like) metal fine structure is deposited from the metal layer surface as a base point into the resin thin film. The structure and size of such a metal structure may be controlled by controlling the metal salt or ions in the electroless plating bath, the properties of the resin thin film, and other factors such as the temperature of the plating bath, the immersion time, the concentration of the metal salt or ions, and the concentration of the reducing agent or the like.

The time of immersion in the plating bath is preferably from about 1 minute to about 3 hours, and more preferably from about 1 minute to about 1 hour.

The metal to be deposited by electroless plating is preferably the same as those of the metal foil and the metal wiring portion in view of electrical contact resistance or the like, while it may be different from those of the metal foil and the metal wiring portion.

When a given plating process is performed as described above, a metal layer laminate having a metal layer, and a resin thin film and a roughened metal surface layer that are formed on the surface of the metal layer, is obtained.

The metal layer laminate of the invention is characterized in that a fractal-shaped interface structure appears between the resin thin film and the roughened metal surface layer, when it is cut in a normal direction, and the interface structure has a fractal dimension of from 1.05 to 1.50 as calculated using a box counting method with the measurement object region being set to from 50 nm to 5 μm and the box size (pixel size) being set to 1/100 or less of the measurement object region.

Using the method described above, the fractal dimension may be calculated from a photograph of the cross-sectional structure of the interface between the metal and the resin in the metal layer laminate. The process of taking a photograph of the cross-sectional structure may include first processing a sample of the metal layer laminate using a dual-beam FIB system (trade name: DUAL BEAM NOVA 200 NANOLAB, manufactured by FEI Company, at an acceleration voltage of 30 kV) to expose the cross-section of the metal-resin interface and observing the cross-section with a focused ion beam system (trade name: SMI 9200, manufactured by Seiko Instruments Inc.). In this process, image data, each image having an image size of 5 μm to 20 μm, are obtained, and the interface portions (line segments) are extracted from the photographs of the metal-resin cross-section by image processing.

Based on the photographs of the cross-section, the surface roughness Ra is determined as the arithmetic mean roughness according to ISO 4287 (1997) (JIS B-0601 (1994)), and the fractal dimension (box-counting dimension) is calculated using the box-counting method. In an embodiment of the invention, to evaluate the complexity of the structure of a minute region, the region size and the number of pixels are set to 1.25 μm×1.25 μm and 256×256, respectively (namely, the measurement object region is set to 1.25 μm, and the box size (pixel size) is set to 1/256 of the measurement object region).

In a preferred embodiment of the invention, the interface between the metal and the resin has a fractal shape, and the interface structure has a fractal dimension of from 1.05 to 1.50, and preferably from 1.1 to 1.4, as calculated using a box counting method with the measurement object region being set to 50 nm to 5 μm and the box size (pixel size) being set to 1/100 or less of the measurement object region, and the metal layer on which the roughened metal surface layer is formed preferably has a surface roughness Rz of 0.8 μm or less. When such conditions are satisfied, the metal layer laminate of the invention obtained by the production method of the invention is useful for forming wiring portions of multilayer boards or the like, because the metal layer itself has surface smoothness at such a level that its macroscopic surface irregularities do not affect the function of the wiring and because a microscopically complicated surface profile is provided. When a resin layer is formed on the surface of the metal layer laminate of the invention, good adherence is provided between the metal layer and the resin layer. The surface of the metal layer laminate of the invention has a resin thin film so that another resin layer can be placed thereon and closely bonded thereto without removal of the resin thin film. Therefore, the metal layer laminate of the invention is useful for forming a metal-resin laminate having two or more layers.

### EXAMPLES

The invention is more specifically described by reference to the following examples, which are not intended to limit the scope of the invention.

In the examples, unless otherwise stated, the blending amounts are all expressed by “parts by mass,” which is also expressed by “parts.”

### Example 1

### 1-1. Metal Layer

An electrolytic copper foil (having a size of 5 cm×5 cm, a thickness of 18 μm, a surface roughness Ra=0.3 μm) not having undergone surface treatment such as soft etching was used as a substrate, which served as the metal layer. The copper foil was immersed in an aqueous 5% hydrochloric acid solution for 120 seconds and then washed with distilled water.

### 1-2. Preparation of Composition for forming Resin Thin Film

Ten parts by mass of a bisphenol A epoxy resin (185 in epoxy equivalent, trade name: EPICOAT 828, manufactured by Japan Epoxy Resins Co., Ltd.), 20 parts of a cresol novolac epoxy resin (215 in epoxy equivalent, trade name: EPICLON N-673, manufactured by DIC Corporation), and 15 parts of a phenol novolac resin (105 in phenolic hydroxyl equivalent, trade name: PHENOLITE, manufactured by DIC Corporation) were dissolved in 100 parts of methyl ethyl ketone under heating at 40° C. and stirring and then cooled to a room temperature. To the mixture were then added 30 parts of a cyclohexanone varnish of a phenoxy resin derived from EPICOAT 828 and bisphenol S (30% by mass in non-volatile content, 47,000 in weight average molecular weight, trade name: YL6747H30, manufactured by Japan Epoxy Resins Co., Ltd.), 0.8 parts of 2-phenyl-4,5-bis(hydroxymethyl)imidazole, and 0.5 parts of a silicone anti-foaming agent, whereby an epoxy resin varnish was obtained as a composition for forming a resin thin film (resin thin film-forming composition).

### 1-3. Formation of Resin Thin Film

The resin thin film-forming composition was applied to the copper foil by spin coating and dried in a nitrogen-purged oven, whereby a resin thin film-carrying copper foil was obtained. The thickness of the film was about 1.6 μm as estimated by dry weight method.

The resulting resin thin film-carrying metal layer was then subjected to plating. When electroplating was carried out, since a certain power supply portion was necessary, one end portion (1 cm from one edge) of the metal layer surface was masked so that the resin thin film-forming composition would not be deposited thereon, and then the resin thin film was formed as described above. When only electroless plating is carried out, the resin thin film may be formed all over the surface.

### 1-4. Electroless Plating

Only electroless plating was performed in Example 1.

The resin thin film-carrying copper foil was immersed in the electroless copper plating bath (50° C.) described below for 60 minutes. During the immersion, the resin thin film side gradually changed its color to brown.

After the immersion was performed for 60 minutes, the electroless-plated, resin thin film-carrying copper foil was washed with water, whereby a metal layer laminate of Example 1 was obtained.

Composition of the Electroless Plating Bath

| | | |
|---|---|---|
| Copper sulfate pentahydrate | 1.8 | g |
| EDTA | 5.4 | g |
| Sodium hydroxide | 1.5 | g |
| Formaldehyde | 0.9 | g |
| PEG (2,000 in molecular weight) | 0.02 | g |
| SPS (sulfopropyl sulfonate) | 0.1 | mg |
| 2,2-bipyridyl | 2 | mg |
| Water | 170.0 | g |

Calculation of Diffusion Coefficient

The same resin thin film as used in Example 1 was formed with a thickness of about 0.4 μm on a silicone substrate. The product was then immersed in the above electroless plating bath.

Samples were prepared using different immersion periods of time and then each determined for the amount of copper ions present in the depth direction by RBS (Rutherford Backscattering Spectrometry) method. The diffusion coefficient D was determined by fitting using a diffusion equation. The result is shown in Table 1 below.

In Example 2 and the other examples shown below, the measurement was performed in the same manner using the corresponding resin, even when the composition of the resin thin film was changed.

Measurement of Surface Roughness and Fractal Dimension

The resulting metal layer laminate was measured for the fractal dimension and surface roughness of the interface between the roughened metal surface layer and the resin thin film.

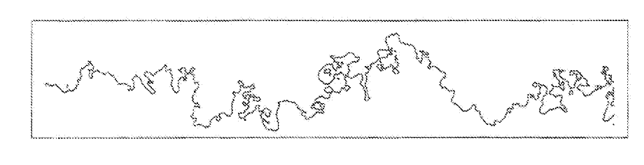

In order to take a photograph of the cross-sectional structure of the copper-clad sheet (metal layer laminate) obtained in Example 1, the cross-section of the sheet sample was exposed by processing using a dual-beam FIB system (trade name: DUAL BEAM NOVA 200 NANOLAB, manufactured by FEI Company, at an acceleration voltage of 30 kV) so that the interface between the copper and the resin could be observed. The cross-section was observed with a focused ion beam system (trade name: SMI 9200, manufactured by Seiko Instruments Inc.), whereby image data each having an image size of 5 μm to 20 μm were obtained. The interface portion (line segments) was extracted from the photograph of the copper-resin cross-section by image processing. FIG. 1 is an image of the interface portion (line segments) extracted from the photograph of the copper-resin cross-section of the metal layer laminate of Example 1.

The surface roughness was determined according to ISO 4288 (1996) (JIS B-0633 (2001)) as the arithmetic mean roughness (Ra) according to ISO 4287 (1997) (JIS B-0601 (1994)). The fractal dimension (box-counting dimension) was calculated using the box-counting method, while the region size was set to 3 μm×3 μm so that the complexity of the fine region structure could be evaluated.

### 1-5. Evaluation of Performance

The resulting metal layer laminate of Example 1 was evaluated for performance as described below. The result is shown in Table 1 below.

### Formation of Insulating Film and Evaluation of Adhesion

The electroless-plated, resin thin film-carrying copper foil was washed with water, and an epoxy insulating film (trade name: GX-13, manufactured by Ajinomoto Fine-Techno Co., Inc., 45 μm) was heat-pressed and bonded to the browned resin thin film side using a vacuum laminator under the conditions of a pressure of 0.2 MPa and 100° C. to 110° C., whereby an electrical insulating layer was formed. A glass epoxy substrate of 1 mm in thickness was further placed on the epoxy insulating film and bonded thereto in the same manner using the vacuum laminator.

The epoxy insulating film was cured and strongly bonded to the glass epoxy substrate by heating at 170° C. for 1 hour, whereby a copper-clad sheet was obtained.

Evaluation of Peel Strength

The peel strength was evaluated based on the 90° peel test according to JIS C-6481 (1996) (corresponding to IEC 60249-1 (1982)). In the test, the copper foil to be peeled off had a width of 1 cm.

In order to evaluate the peel strength in a narrow line width region, straight slit lines with a line and space (L/S) of 40 μm/40 μm and a length of 5 cm were formed by a subtractive process in the copper foil portion of the copper-clad sheet obtained in Example 1. An insulating film was formed on the lines in the same manner as described above, and the copper foil with a line width of 40 μm was peeled off in the same test.

### Example 2

A metal layer laminate was obtained and evaluated in the same manner as in Example 1, except that the resin thin film-forming composition 2 described below was used in place of the resin thin film-forming composition used in Example 1.

### 2-2. Preparation of Resin Thin Film-Forming Composition 2

Fifty parts of a bisphenol A epoxy resin (185 in epoxy equivalent, trade name: EPICOAT 828, manufactured by Japan Epoxy Resins Co., Ltd.) was dissolved in 100 parts of methyl ethyl ketone at 40° C. under heating and stirring and then cooled to room temperature. To the mixture were then added 0.5 parts of 2-phenyl-4,5-bis(hydroxymethyl)imidazole and 0.5 parts of a silicone anti-foaming agent, whereby a resin thin film-forming composition 2 containing an epoxy resin solution was obtained.

### Example 3

A metal layer laminate of Example 3 was obtained and evaluated in the same manner as in Example 1, except that the resin thin film-forming composition 3 described below was used in place of the resin thin film-forming composition used in Example 1.

### 3-2. Preparation of Resin Thin Film-Forming Composition 3

Twenty parts by mass of polystyrene (trade name: GPPS, manufactured by PS Japan Corporation) was added to 200 parts of acetone under stirring to form a solution. Thereafter, 100 parts of acetone was evaporated, whereby a resin thin film-forming composition 3 containing a polystyrene solution was obtained.

### Example 4

A resin thin film was formed on a substrate using the same resin thin film-forming composition as used in Example 1. A metal layer laminate of Example 4 was obtained and evaluated in the same manner as in Example 1, except that when the resin thin film was formed, baking was performed at 170° C. for 1 hour under a nitrogen atmosphere so that the copper foil would not be oxidized, instead of the process of drying the thin film under the conditions of 170° C. and 1 hour in a nitrogen-purged oven, and that the electroless plating time was changed from 60 minutes to 8 hours.

### Example 5

A metal layer laminate of Example 5 was obtained in the same manner as in Example 1, except that the plating method was changed from the electroless plating in Example 1 to electroplating using an electroplating bath under the conditions described below.

In Example 5, when the resin thin film was formed as described above, one end portion (1 cm from one edge) of the metal layer (copper foil) as a base was masked so that a power supply pad portion for electroplating could be maintained, and then coating was performed in the same manner as in Example 1 to form the resin thin film.

The resulting resin thin film-carrying copper foil was immersed in a copper electroplating bath having the composition described below, while a voltage of 20 V was applied to perform electroplating for 15 minutes, whereby the metal layer laminate of Example 5 was obtained.

Composition of Electroplating Bath

| | | |
|---|---|---|
| Copper sulfate | 38 | g |
| Sulfuric acid | 95 | g |
| Hydrochloric acid | 1 | mL |
| COPPER GLEAM PCM (trade name) | 3.5 | mL |
| manufactured by Meltex Inc. | | |
| Water | 500 | g |

### Comparative Example 1

An epoxy insulating film (trade name: GX-13, manufactured by Ajinomoto Fine-Techno Co., Inc., 45 μm) was heat-pressed and bonded onto a glass epoxy substrate using a vacuum laminator under the conditions of a pressure of 0.2 MPa and 100° C. to 110° C., whereby an electrical insulating layer was formed, which was then heated at 170° C. for 30 minutes.

Roughening treatment with potassium permanganate was then performed, and subjected to pretreatment using general commercially available activator (trade name: OPC-80 CATALYST M, manufactured by OKUNO CHEMICAL INDUSTRIES CO, LTD.) and accelerator (trade name: OPC-555 Accelerator M, manufactured by OKUNO CHEMICAL INDUSTRIES CO, LTD.) by standard methods for these pretreatment agents. The resulting surface was immersed for 0.5 hours in the same electroless plating bath as used in Example 1 so that electroless copper plating was performed to form an electroless plating layer as a seed. The electroless plating layer was then used as an electrode and subjected to electroplating at a current density of 3 A/dm² for 20 minutes in the same copper electroplating bath as used in Example 5. After the plating was completed, washing with water was performed.

The copper layer-plated substrate was heated at 170° C. for 1 hour, whereby a metal layer laminate of Comparative Example 1 was obtained, which had an insulating film and a copper layer formed on the surface of the substrate.

The performance evaluation was made in the same manner as in Example 1.

TABLE 1

| | Diffusion coefficient | | | | |
|---|---|---|---|---|---|
| | of copper ions in | Surface roughness | Fractal dimension of | | Wiring peel test |
| | resin thin film | Ra (μm) of metal | roughened metal | 90° peel test (kN/m; | (kN/m; |
| | (m²/second) | layer | surface layer | 1 cm width) | L/S = 40 μm) |
| Example 1 | 9.10 × 10⁻⁷ | 0.38 | 1.25 | 0.87 | 0.79 |
| Example 2 | 5.60 × 10⁻⁶ | 0.42 | 1.08 | 0.75 | 0.68 |
| Example 3 | 5.30 × 10⁻⁸ | 0.37 | 1.10 | 0.68 | 0.63 |
| Example 4 | 4.40 × 10⁻¹¹ | 0.32 | 1.17 | 0.85 | 0.74 |
| Example 5 | 9.10 × 10⁻⁷ | 0.43 | 1.21 | 0.79 | 0.77 |
| Comparative | — | 1.64 | 1.0004 | 0.80 | 0.54 |
| Example 1 | | | | | |

As is evident from Table 1, the metal layer laminates of Examples 1 to 5 showed good adhesion between the metal layer and the resin. Examples 1 to 5 were compared with Comparative Example 1 in which the metal layer surface was roughened without using the method according to the invention. As a result, it was found that the peel strength of the wiring portion with a metal layer line width of 40 μm was higher in Examples 1 to 5 than in Comparative Example 1, although the peel strength with respect to a metal layer line width of 1 cm in Examples 1 to 5 was considered to be not higher than but substantially equal to that in Comparative Example 1. This may be because in Examples 1 to 5, a fine complicated structure resulting from the formation of the roughened metal surface layer effectively has an anchoring effect, even when the line width is reduced, although the surface roughness is small as indicated by Ra and the box-counting dimension.

A comparison between Examples 1 and 4 shows that even when the metal ions have a small diffusion coefficient in the resin material, a sufficient electroless plating time such as 8 hours in Example 4 makes it possible to form a fine structure in the scope of the invention, so that the desired peel strength can be achieved. On the other hand, it is also apparent that when a resin material in which metal ions have a diffusion coefficient in a preferred range of the invention is selected and used to form the resin thin film, preferred conditions according to the invention can be provided even with a relatively short period of plating time, such as 60 minutes, and therefore, the metal layer laminate can be effectively formed.

### Example 6

A circuit with a line and space (L/S) of 40 μm/40 μm was formed in the copper layer of a commercially available, one-side copper-clad glass epoxy board by a subtractive process, whereby a wiring board was obtained.

The copper wiring portion of the copper wiring board was used as the metal layer. Using the same resin thin film-forming composition as that in Example 1, a resin thin film was formed on the surface of the copper wiring board. Under the same conditions as those in Example 1, an electroless plating process was then performed. After washing with water and drying, a metal layer laminate of Example 6 was obtained.

A solder resist layer was formed on the circuit board, whereby a protective film-carrying circuit board was obtained.

Method of Thermal Shock Residence Test

Since the metal layer serving as the base of the metal layer laminate of Example 6 was a fine wiring portion, the adhesion between the metal layer and a resin layer was evaluated by a thermal shock resistance test, which was performed in place of the peel test in Example 1.

For the thermal shock resistance test, an epoxy insulating layer and a glass epoxy substrate having a thickness of 1 mm were laminated on the metal layer laminate of Example 6 to form a sample.

Using a high-low temperature thermal shock test chamber (trade name: TSA-71S-A/W, manufactured by ESPEC CORP), the sample was subjected to 200 cycles of exposure to a low temperature (−55° C.) for 30 minutes and exposure to a high temperature (125° C.) for 30 minutes, based on the condition A of MIL-STD-883E (−55° C. to 125° C.). How the copper wiring portion and the copper-resin interface were damaged was observed using an optical micrograph (transmitted light, magnification: ×25 to ×100) and cross-sectional SEM (magnification: ×5,000), and a visual evaluation was performed based on the criteria shown below. The sample with a smaller number of damaged portions was evaluated as having better adhesion.

A: One or no damaged portion was observed under the above conditions.
B: Two to five damaged portions were observed under the above conditions.
C: Six to ten damaged portions were observed under the above conditions.
D: Eleven or more damaged portions were observed under the above conditions.

### Comparative Example 2

A circuit with a line and space (L/S) of 40 μm/40 μm was formed in the copper layer of a commercially available, one-side copper-clad glass epoxy board by a subtractive process, so that a wiring board was obtained in the same manner as in Example 6.

The wiring portion surface of the wiring board was subjected to a surface roughening process using a soft etching solution (a mixture of 120 to 180 g/l of a commercially available product MELPLATE AD-331 (trade name) manufactured by Meltex Inc. and 10 ml/l of 98% sulfuric acid) at a temperature of 45° C. for 1 minute. An epoxy insulating film and a glass epoxy substrate having a thickness of 1 mm were laminated on the wiring portion surface in the same manner as in Example 1, whereby a sample was obtained.

The resulting sample was subjected to the same thermal shock resistance test as in Example 6. The result is shown in Table 2.

TABLE 2

| | Diffusion coefficient of | | Fractal dimension of | |
|---|---|---|---|---|
| | copper ions in resin thin | Surface roughness Ra | roughened metal surface | Thermal shock resistance |
| | film (m²/second) | (μm) of metal layer | layer | test |
| Example 6 | 9.10 × 10⁻⁷ | 0.38 | 1.25 | A |
| Comparative | — | 1.13 | — | C |
| Example 2 | | | | |

Table 2 shows that the metal layer laminate of the invention had good adhesion to the adjacent insulating resin layer. It is considered that the peel strength between the wiring portion and the resin was high, and the wiring portion and the resin was bound together by a strong force, and, therefore, breakage was prevented in Example 6. In contrast, it is apparent that even when surface-roughening treatment was performed, the wiring portion of Comparative Example 2 had low adhesion to the adjacent resin layer and therefore produced a large number of defects under the thermal conditions.

As described above, the production method of the invention makes it possible to produce a metal layer laminate having a roughened metal surface layer with good adhesion to adjacent resin layers, and the resulting metal layer laminate of the invention is useful in manufacturing multilayer circuit boards such as flexible circuit boards, because it can achieve sufficient adhesion to resin layers, even when the metal layer as a base has a small surface roughness.

1. A metal layer laminate, comprising a metal layer, a resin thin film, and a roughened metal surface layer, wherein
the resin thin film and the roughened metal surface layer are formed on a surface of the metal layer,
a fractal-shaped interface structure appears between the resin thin film and the roughened metal surface layer when the metal layer laminate is cut in a normal direction, and
the interface structure has a fractal dimension of from 1.05 to 1.50 as calculated using a box counting method with a measurement object region being set to from 50 nm to 5 μm and a box size being set to 1/100 or less of the measurement object region.

2. The metal layer laminate of claim 1, wherein the interface structure has a fractal dimension of from 1.1 to 1.4.

3. The metal layer laminate of claim 1, wherein the resin thin film comprises a thermosetting resin, a thermoplastic resin or a mixture thereof.

4. The metal layer laminate of claim 3, wherein the resin thin film comprises at least one selected from the group consisting of epoxy resin, phenolic resin, polyimide resin, polyester resin, bismaleimide resin, polyolefin resin, isocyanate resin, phenoxy resin, polyether sulfone, polysulfone, polyphenylene sulfone, polyphenylene sulfide, polyphenyl ether, and polyether imide.

5. A method for producing a metal layer laminate comprising a metal layer and a roughened metal surface layer provided on a surface of the metal layer, the method comprising:
forming a resin thin film on a surface of a metal layer; and
immersing the resin thin film-carrying metal layer in an electroplating solution or an electroless plating solution to subject it to a plating process.

6. The method of claim 5, wherein the metal layer is a metal foil or a metal wiring portion of a printed circuit board comprising a substrate and a circuit formed thereon.

7. The method of claim 5, wherein the metal layer has an arithmetic mean roughness Ra of 0.5 μm or less as determined according to ISO 4287 (1997).

8. The method of claim 5, wherein the resin thin film has a thickness in the range of 0.1 to 10 μm, and a metal ion or a metal salt present in the electroless plating solution or in the electroplating solution has a diffusion coefficient of 10-4 m²/second to 10-10 m²/second in the resin thin film.

9. The method of claim 5, wherein the roughened metal surface layer has an arithmetic mean roughness Ra of 0.5 μm or less as determined according to ISO 4287 (1997).

10. The method of claim 5, wherein a fractal-shaped interface structure appears between the roughened metal surface layer and the resin thin film, when the metal layer laminate is cut in a normal direction, and the interface structure has a fractal dimension of from 1.05 to 1.50 as calculated using a box counting method with a measurement object region being set to from 50 nm to 5 μm and a box size being set to 1/100 or less of the measurement object region.

11. The method of claim 5, wherein the resin thin film comprises a thermosetting resin, a thermoplastic resin or a mixture thereof.

12. The method of claim 11, wherein the resin thin film comprises at least one selected from the group consisting of epoxy resin, phenolic resin, polyimide resin, polyester resin, bismaleimide resin, polyolefin resin, isocyanate resin, phenoxy resin, polyether sulfone, polysulfone, polyphenylene sulfone, polyphenylene sulfide, polyphenyl ether, and polyether imide.

13. The method of claim 6, wherein the metal layer has an arithmetic mean roughness Ra of 0.5 μm or less as determined according to ISO 4287 (1997).

14. The method of claim 6, wherein the resin thin film has a thickness in the range of 0.1 to 10 μm, and a metal ion or a metal salt present in the electroless plating solution or in the electroplating solution has a diffusion coefficient of 10-4 m²/second to 10-10 m²/second in the resin thin film.

15. The method of claim 6, wherein the roughened metal surface layer has an arithmetic mean roughness Ra of 0.5 μm or less as determined according to ISO 4287 (1997).

16. The method of claim 6, wherein a fractal-shaped interface structure appears between the roughened metal surface layer and the resin thin film, when the metal layer laminate is cut in a normal direction, and the interface structure has a fractal dimension of from 1.05 to 1.50 as calculated using a box counting method with a measurement object region being set to from 50 nm to 5 μm and a box size being set to 1/100 or less of the measurement object region.
